(19) United States
(12) Patent Application Publication
(10) Pub. No.: US 2014/0369517 A1
(43) Pub. Date: Dec. 18, 2014

(54) SYSTEMS AND METHODS FOR DETECTION AND CANCELLATION OF NARROW-BAND NOISE

(71) Applicant: Cirrus Logic, Inc., Austin, TX (US)

(72) Inventors: Dayong Zhou, Austin, TX (US); Yang Lu, Austin, TX (US)

(21) Appl. No.: 13/917,843

(22) Filed: Jun. 14, 2013

(51) Int. Cl. G10K 11/178

(52) U.S. Cl. CPC G10K 11/178
USPC 381/71.11

(57) ABSTRACT

In accordance with methods and systems of the present disclosure, an integrated circuit for implementing at least a portion of a personal audio device may include an output including an anti-noise signal, a reference microphone input, an error microphone input, and a processing circuit. The processing circuit may implement an adaptive filter having a response that generates the anti-noise signal from the reference microphone signal to reduce the presence of the ambient audio sounds heard by the listener, wherein the processing circuit may implement a coefficient control block that shapes the response of the adaptive filter in conformity with the error microphone signal and the reference microphone signal by adapting the response of the adaptive filter in accordance with a calculated narrow-band-to-full-band ratio, wherein the narrow-band-to-full-band ratio is a function of a narrow-band power of the reference microphone signal divided by a full-band power of the reference microphone signal.

### FIELD OF DISCLOSURE

The present disclosure relates in general to adaptive noise cancellation in connection with an acoustic transducer, and more particularly, to detection and cancellation of ambient narrow-band noise present in the vicinity of the acoustic transducer.

### BACKGROUND

Wireless telephones, such as mobile/cellular telephones, cordless telephones, and other consumer audio devices, such as mp3 players, are in widespread use. Performance of such devices with respect to intelligibility can be improved by providing noise canceling using a microphone to measure ambient acoustic events and then using signal processing to insert an anti-noise signal into the output of the device to cancel the ambient acoustic events.

Because the acoustic environment around personal audio devices, such as wireless telephones, can change dramatically, depending on the sources of noise that are present and the position of the device itself, it is desirable to adapt the noise canceling to take into account such environmental changes. However, adaptive noise canceling circuits can be complex, consume additional power, and can generate undesirable results under certain circumstances. For example, some users of personal audio devices which include adaptive noise canceling circuitry report discomfort when using such devices while traveling in a vehicle, such discomfort including dizziness, disorientation, and pressure sensations.

### SUMMARY

In accordance with the teachings of the present disclosure, the disadvantages and problems associated with detection and reduction of ambient narrow-band noise associated with an acoustic transducer may be reduced or eliminated.

In accordance with embodiments of the present disclosure, a personal audio device may include a personal audio device housing, a transducer, a reference microphone, an error microphone, and a processing circuit. The transducer may be mounted on the housing for reproducing an audio signal including both source audio for playback to a listener and an anti-noise signal for countering the effects of ambient audio sounds in an acoustic output of the transducer. The reference microphone may be mounted on the housing for providing a reference microphone signal indicative of the ambient audio sounds. The error microphone may be mounted on the housing in proximity to the transducer for providing an error microphone signal indicative of the acoustic output of the transducer and the ambient audio sounds at the transducer. The processing circuit may implement an adaptive filter having a response that generates the anti-noise signal from the reference microphone signal to reduce the presence of the ambient audio sounds heard by the listener, wherein the processing circuit may implement a coefficient control block that shapes the response of the adaptive filter in conformity with the error microphone signal and the reference microphone signal by adapting the response of the adaptive filter in accordance with a calculated narrow-band-to-full-band ratio, wherein the narrow-band-to-full-band ratio is a function of a narrow-band power of the reference microphone signal divided by a full-band power of the reference microphone signal.

In accordance with these and other embodiments of the present disclosure, a method for canceling ambient audio sounds in the proximity of a transducer of a personal audio device may include measuring ambient audio sounds with a reference microphone to produce a reference microphone signal. The method may also include measuring an output of the transducer and the ambient audio sounds at the transducer with an error microphone. The method may additionally include adaptively generating an anti-noise signal from a result of the measuring with the reference microphone and the measuring with the error microphone for countering the effects of ambient audio sounds at an acoustic output of the transducer by adapting a response of an adaptive filter that filters an output of the reference microphone in accordance with a calculated narrow-band-to-full-band ratio, wherein the narrow-band-to-full-band ratio is a function of a narrow-band power of the reference microphone signal divided by a full-band power of the reference microphone signal. The method may further include combining the anti-noise signal with a source audio signal to generate an audio signal provided to the transducer.

In accordance with these and other embodiments of the present disclosure, an integrated circuit for implementing at least a portion of a personal audio device may include an output, a reference microphone input, and error microphone input, and a processing circuit. The output may be for providing a signal to a transducer including both source audio for playback to a listener and an anti-noise signal for countering the effect of ambient audio sounds in an acoustic output of the transducer. The reference microphone input may be for receiving a reference microphone signal indicative of the ambient audio sounds. The error microphone input may be for receiving an error microphone signal indicative of the output of the transducer and the ambient audio sounds at the transducer. The processing circuit may implement an adaptive filter having a response that generates the anti-noise signal from the reference microphone signal to reduce the presence of the ambient audio sounds heard by the listener, wherein the processing circuit may implement a coefficient control block that shapes the response of the adaptive filter in conformity with the error microphone signal and the reference microphone signal by adapting the response of the adaptive filter in accordance with a calculated narrow-band-to-full-band ratio, wherein the narrow-band-to-full-band ratio is a function of a narrow-band power of the reference microphone signal divided by a full-band power of the reference microphone signal.

Technical advantages of the present disclosure may be readily apparent to one of ordinary skill in the art from the figures, description and claims included herein. The objects and advantages of the embodiments will be realized and achieved at least by the elements, features, and combinations particularly pointed out in the claims.

It is to be understood that both the foregoing general description and the following detailed description are examples and explanatory and are not restrictive of the claims set forth in this disclosure.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 is an illustration of a wireless mobile telephone, in accordance with embodiments of the present disclosure;

FIG. 2 is a block diagram of selected circuits within the wireless telephone depicted in FIG. 1, in accordance with embodiments of the present disclosure; and

FIG. 3 is a block diagram depicting selected signal processing circuits and functional blocks within an active noise canceling (ANC) circuit of a coder-decoder (CODEC) integrated circuit of FIG. 3, in accordance with embodiments of the present disclosure.

### DETAILED DESCRIPTION

The present disclosure encompasses noise canceling techniques and circuits that can be implemented in a personal audio device, such as a wireless telephone. The personal audio device includes an ANC circuit that may measure the ambient acoustic environment and generate a signal that is injected in the speaker (or other transducer) output to cancel ambient acoustic events. A reference microphone may be provided to measure the ambient acoustic environment and an error microphone may be included for controlling the adaptation of the anti-noise signal to cancel the ambient audio sounds and for correcting for the electro-acoustic path from the output of the processing circuit through the transducer.

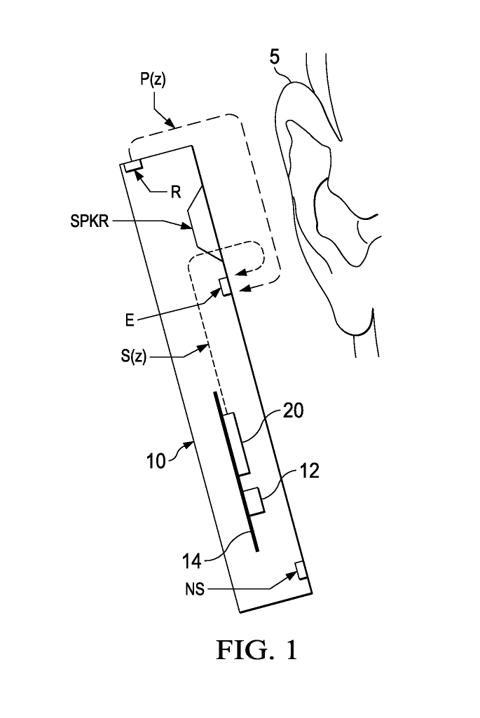

Referring now to FIG. 1, a wireless telephone 10 as illustrated in accordance with embodiments of the present disclosure is shown in proximity to a human ear 5. Wireless telephone 10 is an example of a device in which techniques in accordance with embodiments of the invention may be employed, but it is understood that not all of the elements or configurations embodied in illustrated wireless telephone 10, or in the circuits depicted in subsequent illustrations, are required in order to practice the invention recited in the claims. Wireless telephone 10 may include a transducer such as speaker SPKR that reproduces distant speech received by wireless telephone 10, along with other local audio events such as ringtones, stored audio program material, injection of near-end speech (i.e., the speech of the user of wireless telephone 10) to provide a balanced conversational perception, and other audio that requires reproduction by wireless telephone 10, such as sources from webpages or other network communications received by wireless telephone 10 and audio indications such as a low battery indication and other system event notifications. A near-speech microphone NS may be provided to capture near-end speech, which is transmitted from wireless telephone 10 to the other conversation participant(s).

Wireless telephone 10 may include ANC circuits and features that inject an anti-noise signal into speaker SPKR to improve intelligibility of the distant speech and other audio reproduced by speaker SPKR. A reference microphone R may be provided for measuring the ambient acoustic environment, and may be positioned away from the typical position of a user's mouth, so that the near-end speech may be minimized in the signal produced by reference microphone R. Another microphone, error microphone E, may be provided in order to further improve the ANC operation by providing a measure of the ambient audio combined with the audio reproduced by speaker SPKR close to ear 5, when wireless telephone 10 is in close proximity to ear 5. Circuit 14 within wireless telephone 10 may include an audio CODEC integrated circuit (IC) 20 that receives the signals from reference microphone R, near-speech microphone NS, and error microphone E and interfaces with other integrated circuits such as a radio-frequency (RF) integrated circuit 12 having a wireless telephone transceiver. In some embodiments of the disclosure, the circuits and techniques disclosed herein may be incorporated in a single integrated circuit that includes control circuits and other functionality for implementing the entirety of the personal audio device, such as an MP3 player-on-a-chip integrated circuit.

In general, ANC techniques of the present disclosure measure ambient acoustic events (as opposed to the output of speaker SPKR and/or the near-end speech) impinging on reference microphone R, and by also measuring the same ambient acoustic events impinging on error microphone E, ANC processing circuits of wireless telephone 10 adapt an anti-noise signal generated from the output of reference microphone R to have a characteristic that minimizes the amplitude of the ambient acoustic events at error microphone E. Because acoustic path P(z) extends from reference microphone R to error microphone E, ANC circuits are effectively estimating acoustic path P(z) while removing effects of an electro-acoustic path S(z) that represents the response of the audio output circuits of CODEC IC 20 and the acoustic/electric transfer function of speaker SPKR including the coupling between speaker SPKR and error microphone E in the particular acoustic environment, which may be affected by the proximity and structure of ear 5 and other physical objects and human head structures that may be in proximity to wireless telephone 10, when wireless telephone 10 is not firmly pressed to ear 5. While the illustrated wireless telephone 10 includes a two-microphone ANC system with a third near-speech microphone NS, some aspects of the present invention may be practiced in a system that does not include separate error and reference microphones, or a wireless telephone that uses near-speech microphone NS to perform the function of the reference microphone R. Also, in personal audio devices designed only for audio playback, near-speech microphone NS will generally not be included, and the near-speech signal paths in the circuits described in further detail below may be omitted, without changing the scope of the disclosure, other than to limit the options provided for input to the microphone covering detection schemes.

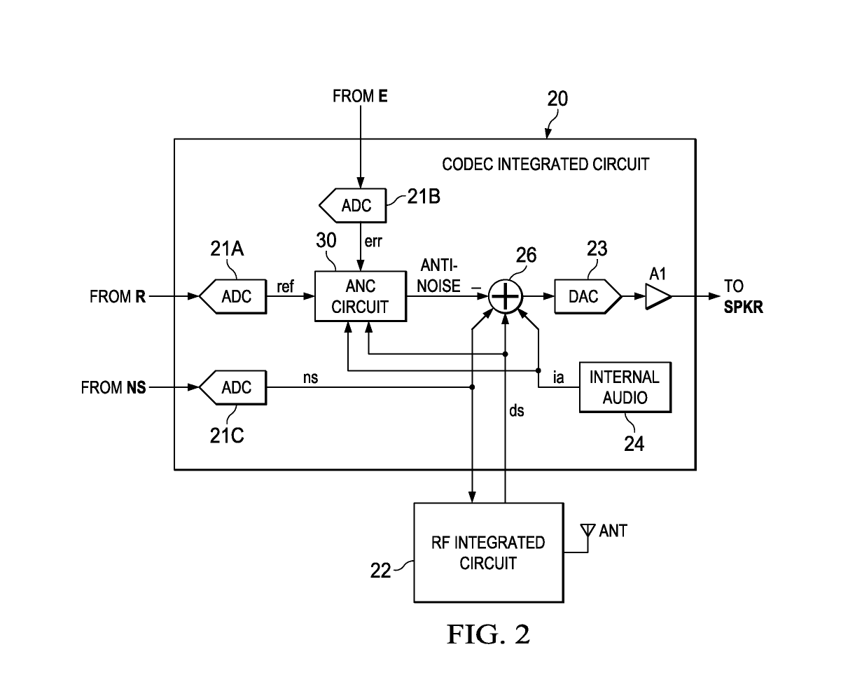

Referring now to FIG. 2, selected circuits within wireless telephone 10 are shown in a block diagram. CODEC IC 20 may include an analog-to-digital converter (ADC) 21A for receiving the reference microphone signal and generating a digital representation ref of the reference microphone signal, an ADC 21B for receiving the error microphone signal and generating a digital representation err of the error microphone signal, and an ADC 21C for receiving the near speech microphone signal and generating a digital representation ns of the near speech microphone signal. CODEC IC 20 may generate an output for driving speaker SPKR from an amplifier A1, which may amplify the output of a digital-to-analog converter (DAC) 23 that receives the output of a combiner 26. Combiner 26 may combine audio signals is from internal audio sources 24, the anti-noise signal generated by ANC circuit 30, which by convention has the same polarity as the noise in reference microphone signal ref and is therefore subtracted by combiner 26, and a portion of near speech microphone signal ns so that the user of wireless telephone 10 may hear his or her own voice in proper relation to downlink speech ds, which may be received from radio frequency (RF) integrated circuit 22 and may also be combined by combiner 26. Near speech microphone signal ns may also be provided to RF integrated circuit 22 and may be transmitted as uplink speech to the service provider via antenna ANT.

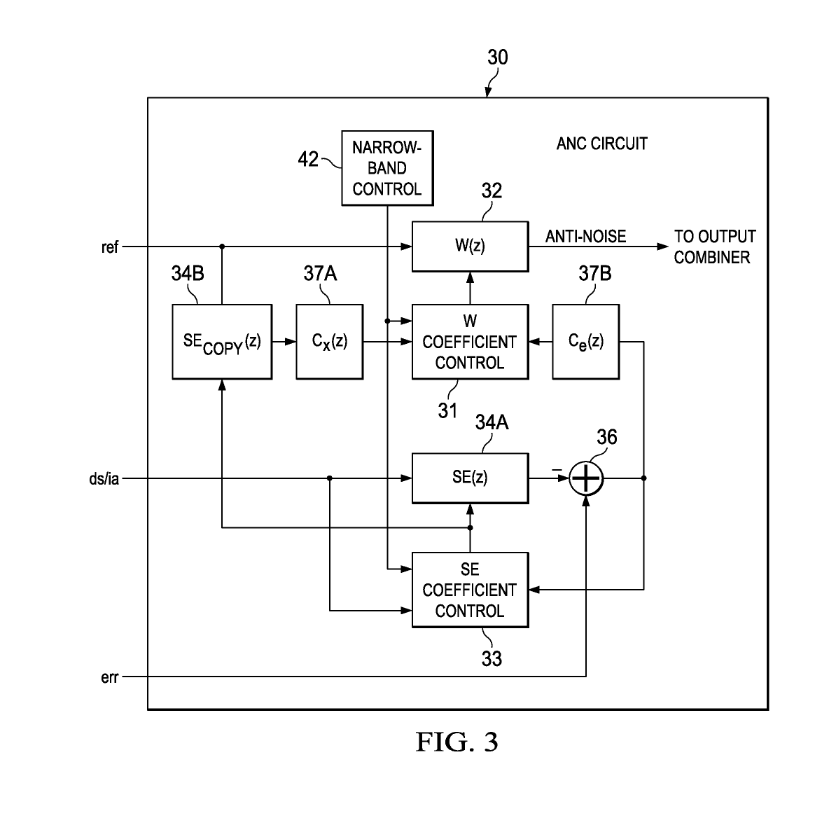

Referring now to FIG. 3, details of ANC circuit 30 are shown in accordance with embodiments of the present disclosure. Adaptive filter 32 may receive reference microphone signal ref and under ideal circumstances, may adapt its transfer function W(z) to be P(z)/S(z) to generate the anti-noise signal, which may be provided to an output combiner that combines the anti-noise signal with the audio to be reproduced by the transducer, as exemplified by combiner 26 of FIG. 2. The coefficients of adaptive filter 32 may be controlled by a W coefficient control block 31 that uses a correlation of signals to determine the response of adaptive filter 32, which generally minimizes the error, in a least-mean squares sense, between those components of reference microphone signal ref present in error microphone signal err. The signals compared by W coefficient control block 31 may be the reference microphone signal ref as shaped by a copy of an estimate of the response of path S(z) provided by filter 34B and another signal that includes error microphone signal err. By transforming reference microphone signal ref with a copy of the estimate of the response of path S(z), response SE_{COPY}(z), and minimizing the difference between the resultant signal and error microphone signal err, adaptive filter 32 may adapt to the desired response of P(z)/S(z). In addition, a filter 37A that has a response Cₓ(z) as explained in further detail below, may process the output of filter 34B and provide the first input to W coefficient control block 31. The second input to W coefficient control block 31 may be processed by another filter 37B having a response of Cₑ(z). Response Cₑ(z) may have a phase response matched to response Cₓ(z) of filter 37A. Both filters 37A and 37B may include a highpass response, so that DC offset and very low frequency variation are prevented from affecting the coefficients of W(z). In addition to error microphone signal err, the signal compared to the output of filter 34B by W coefficient control block 31 may include an inverted amount of downlink audio signal ds and/or internal audio signal ia that has been processed by filter response SE(z), of which response SE_{COPY}(z) is a copy. By injecting an inverted amount of downlink audio signal ds and/or internal audio signal ia, adaptive filter 32 may be prevented from adapting to the relatively large amount of downlink audio and/or internal audio signal present in error microphone signal err and by transforming that inverted copy of downlink audio signal ds and/or internal audio signal ia with the estimate of the response of path S(z), the downlink audio and/or internal audio that is removed from error microphone signal err before comparison should match the expected version of downlink audio signal ds and/or internal audio signal ia reproduced at error microphone signal err, because the electrical and acoustical path of S(z) is the path taken by downlink audio signal ds and/or internal audio signal ia to arrive at error microphone E. Filter 34B may not be an adaptive filter, per se, but may have an adjustable response that is tuned to match the response of adaptive filter 34A, so that the response of filter 34B tracks the adapting of adaptive filter 34A.

To implement the above, adaptive filter 34A may have coefficients controlled by SE coefficient control block 33, which may compare downlink audio signal ds and/or internal audio signal ia and error microphone signal err after removal of the above-described filtered downlink audio signal ds and/or internal audio signal ia, that has been filtered by adaptive filter 34A to represent the expected downlink audio delivered to error microphone E, and which is removed from the output of adaptive filter 34A by a combiner 36. SE coefficient control block 33 correlates the actual downlink speech signal ds and/or internal audio signal ia with the components of downlink audio signal ds and/or internal audio signal ia that are present in error microphone signal err. Adaptive filter 34A may thereby be adapted to generate a signal from downlink audio signal ds and/or internal audio signal ia, that when subtracted from error microphone signal err, contains the content of error microphone signal err that is not due to downlink audio signal ds and/or internal audio signal ia.

Narrow-band control block 42 of ANC circuit 30 may be configured to detect and cancel narrow-band noise, such as that which may be present due to sound vibrations between tires and a roadway when a user of wireless phone 10 or another personal audio device is listening to sound generated by an audio transducer while driving or traveling in a vehicle. To perform such functionality, narrow-band control block 42 may calculate a narrow-band-to-full-band ratio, wherein the narrow-band-to-full-band ratio is a function of a narrow-band power of the reference microphone signal occurring within a particular frequency range divided by a full-band power of the reference microphone signal. The particular frequency range may be any suitable band of interest for which it may be desirable to detect and cancel noise occurring in such particular frequency range. For example, in some embodiments, the particular frequency range may be between approximately 50 Hz and approximately 380 Hz, corresponding to noise that may be present due to travel in a vehicle. The higher the narrow-band-to-full-band ratio is, the less stable the adaptive system of ANC circuit 30 may be, thus leading to undesirable operation of ANC circuitry. Accordingly, based on the value of the narrow-band-to-full-band ratio, narrow-band control block 42 may generate control signals (not shown in FIG. 3) for controlling one or more other blocks of ANC circuit 30. For example, as the narrow-band-to-full-band ratio increases, narrow-band control block 42 may decrease the step size of the various coefficients for filters 32 and 34A, and vice versa. As another example, as the narrow-band-to-full-band ratio increases, narrow-band control block 42 may decrease the gain of one or more of filters 32 and 34A, and vice versa, by appropriately scaling the coefficients in accordance with the desired gain. To vary the gain of one or more filters 32 and 34A, approaches may be used similar or identical to those disclosed in U.S. patent application Ser. No. 13/333,484 filed Dec. 21, 2011 and titled “Bandlimiting Anti-Noise in Personal Audio Devices Having Adaptive Noise Cancellation (ANC),” which is incorporated by reference herein for all relevant purposes.

In its simplest form, the narrow-band-to-full-band ratio may be calculated as the narrow-band power divided by the full-band power. However, various approaches may be used to smooth the narrow-band-to-full-band ratio over time or increase its robustness by limiting or eliminating the effects of disturbances or outliers that may otherwise undesirably contribute to the narrow-band-to-full-band ratio calculation. For example, to smooth the narrow-band-to-full-band ratio over time, the narrow-band-to-full-band ratio may be calculated as:

NFRₙ=αNFRₙ₋₁+(1−α)(Present Narrow-Band Power/Present Full-Band Power)

where NFRₙ is the value of the narrow-band-to-full-band ratio at a given discrete time interval n, NFRₙ₋₁ is the value of the narrow-band-to-full-band ratio at a previous discrete time interval n−1, and α is a smoothing factor that determines the relative weight in the calculation for the narrow-band-to-full-band ratio at a previous discrete time interval n−1, such that as α increases, the response of the narrow-band-to-full-band ratio is smoother, and vice versa. Thus, the narrow-band-to-full-band ratio may be calculated as a blended average of a previous value of the narrow-band-to-full-band ratio and a quantity equal to a present narrow-band power of the reference microphone signal divided by a present full-band power of the reference microphone signal.

As another example, to improve the robustness of the narrow-band control block as compared to the calculation given above, the narrow-band-to-full-band ratio may be calculated as:

NFRₙ=αNFRₙ₋₁+(1−α)(Present Narrow-Band Power/Adjusted Present Full-Band Power)

where the Adjusted Present Full-Band power equals the Present Full-Band Power of the reference microphone minus signal outliers present outside of the particular frequency range of the narrow-band power. Such signal outliers may be defined and/or identified in any suitable manner. For example, a signal outlier may comprise a signal at a particular frequency of the full-band power spectrum occurring outside of the narrow-band frequency range wherein the amplitude at such frequency is significantly larger (e.g., two times, 10 times, etc.) than the amplitude at neighboring frequencies. Thus, the narrow-band-to-full-band ratio is calculated as a blended average of a previous value of the narrow-band-to-full-band ratio and a quantity equal to a present narrow-band power of the reference microphone signal divided by a quantity equal to a present full-band power of the reference microphone signal minus a present power of reference microphone signal outliers present outside of a frequency range of the narrow-band power.

As another example, to improve the robustness of the narrow-band control block as compared to the calculation given above, the narrow-band-to-full-band ratio may be calculated as:

NFRₙ=αNFRₙ₋₁+(1−α)(Present Narrow-Band Power/Adjusted Present Full-Band Power)

when no signal disturbances are detected during a discrete time interval n, and:

NFRₙ=NFRₙ₋₁

when a signal disturbance is detected during a discrete time interval n. As used herein, the term “signal disturbance” may include any sound impinging on the reference microphone that might be expected to falsely influence detection of narrow-band noise, and may include bursty speech or other sounds occurring close to the reference microphone, the presence of ambient wind, physical contact of an object with the reference microphone, a momentary tone, and/or any other similar sound. Such a disturbance may be detected by the reference microphone, another microphone, and/or any other sensor associated with the personal audio device.

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

All examples and conditional language recited herein are intended for pedagogical objects to aid the reader in understanding the invention and the concepts contributed by the inventor to furthering the art, and are construed as being without limitation to such specifically recited examples and conditions. Although embodiments of the present inventions have been described in detail, it should be understood that various changes, substitutions, and alterations could be made hereto without departing from the spirit and scope of the disclosure.

1. A personal audio device comprising:
a personal audio device housing;
a transducer coupled to the housing for reproducing an audio signal including both source audio for playback to a listener and an anti-noise signal for countering the effects of ambient audio sounds in an acoustic output of the transducer;
a reference microphone coupled to the housing for providing a reference microphone signal indicative of the ambient audio sounds;
an error microphone coupled to the housing in proximity to the transducer for providing an error microphone signal indicative of the acoustic output of the transducer and the ambient audio sounds at the transducer; and
a processing circuit that implements an adaptive filter having a response that generates the anti-noise signal from the reference microphone signal to reduce the presence of the ambient audio sounds heard by the listener, wherein the processing circuit implements a coefficient control block that shapes the response of the adaptive filter in conformity with the error microphone signal and the reference microphone signal by adapting the response of the adaptive filter to minimize the ambient audio sounds in the error microphone signal and by further adapting the response of the adaptive filter in accordance with a calculated narrow-band-to-full-band ratio, wherein the narrow-band-to-full-band ratio is a function of a narrow-band power of the reference microphone signal divided by a full-band power of the reference microphone signal.

2. The personal audio device of claim 1, wherein the narrow-band-to-full-band ratio is calculated as a blended average of a previous value of the narrow-band-to-full-band ratio and a quantity equal to a present narrow-band power of the reference microphone signal divided by a present full-band power of the reference microphone signal.

3. The personal audio device of claim 1, wherein the narrow-band-to-full-band ratio is calculated as a blended average of a previous value of the narrow-band-to-full-band ratio and a quantity equal to a present narrow-band power of the reference microphone signal divided by a quantity equal to a present full-band power of the reference microphone signal minus a present power of reference microphone signal outliers present outside of a frequency range of the narrow-band power.

4. The personal audio device of claim 1, wherein:
the narrow-band-to-full-band ratio is calculated as a blended average of a previous value of the narrow-band-to-full-band ratio and a quantity equal to a present narrow-band power of the reference microphone signal divided by a present full-band power of the reference microphone signal responsive to a determination that no disturbance is detected on the reference microphone signal; and
the narrow-band-to-full-band ratio is calculated as equal to the previous value of the narrow-band-to-full-band ratio reference microphone signal responsive to a determination that a disturbance is detected on the reference microphone signal.

5. The personal audio device of claim 1, wherein the narrow-band power comprises a power of the reference microphone signal for frequencies between approximately 50 Hz and approximately 380 Hz.

6. The personal audio device of claim 1, wherein the processing circuitry adapts the response of the adaptive filter in accordance with the calculated narrow-band-to-full-band ratio by controlling a step size of at least one coefficient of the coefficient control block based on the calculated narrow-band-to-full-band ratio.

7. The personal audio device of claim 1, wherein the processing circuitry adapts the response of the adaptive filter in accordance with the calculated narrow-band-to-full-band ratio by controlling an adaptive noise control gain of the adaptive filter based on the calculated narrow-band-to-full-band ratio.

8. The personal audio device of claim 1, wherein the narrow-band power of the reference microphone signal is attributable primarily to ambient noise caused by travel in a vehicle.

9. A method for canceling ambient audio sounds in the proximity of a transducer of a personal audio device, the method comprising:
receiving a reference microphone signal indicative of the ambient audio sounds;
receiving an error microphone signal indicative of the output of the transducer and the ambient audio sounds at the transducer;
adaptively generating an anti-noise signal, from a result of the measuring with the reference microphone and the measuring with the error microphone, for countering the effects of ambient audio sounds at an acoustic output of the transducer by adapting a response of an adaptive filter that filters an output of the reference microphone to minimize the ambient audio sounds in the error microphone signal, and further filters the output of the reference microphone in accordance with a calculated narrow-band-to-full-band ratio, wherein the narrow-band-to-full-band ratio is a function of a narrow-band power of the reference microphone signal divided by a full-band power of the reference microphone signal; and
combining the anti-noise signal with a source audio signal to generate an audio signal provided to the transducer.

10. The method of claim 9, wherein the narrow-band-to-full-band ratio is calculated as a blended average of a previous value of the narrow-band-to-full-band ratio and a quantity equal to a present narrow-band power of the reference microphone signal divided by a present full-band power of the reference microphone signal.

11. The method of claim 9, wherein the narrow-band-to-full-band ratio is calculated as a blended average of a previous value of the narrow-band-to-full-band ratio and a quantity equal to a present narrow-band power of the reference microphone signal divided by a quantity equal to a present full-band power of the reference microphone signal minus a present power of reference microphone signal outliers present outside of a frequency range of the narrow-band power.

12. The method of claim 9, wherein:
the narrow-band-to-full-band ratio is calculated as a blended average of a previous value of the narrow-band-to-full-band ratio and a quantity equal to a present narrow-band power of the reference microphone signal divided by a present full-band power of the reference microphone signal responsive to a determination that no disturbance is detected on the reference microphone signal; and
the narrow-band-to-full-band ratio is calculated as equal to the previous value of the narrow-band-to-full-band ratio reference microphone signal responsive to a determination that a disturbance is detected on the reference microphone signal.

13. The method of claim 9, wherein the narrow-band power comprises a power of the reference microphone signal for frequencies between approximately 50 Hz and approximately 380 Hz.

14. The method of claim 9, wherein adapting the response of the adaptive filter in accordance with the calculated narrow-band-to-full-band ratio comprises controlling a step size of at least one coefficient of the coefficient control block based on the calculated narrow-band-to-full-band ratio.

15. The method of claim 9, wherein adapting the response of the adaptive filter in accordance with the calculated narrow-band-to-full-band ratio comprises controlling an adaptive noise control gain of the adaptive filter based on the calculated narrow-band-to-full-band ratio.

16. The method of claim 9, wherein the narrow-band power of the reference microphone signal is attributable primarily to ambient noise caused by travel in a vehicle.

17. An integrated circuit for implementing at least a portion of a personal audio device, comprising:
an output for providing a signal to a transducer including both source audio for playback to a listener and an anti-noise signal for countering the effect of ambient audio sounds in an acoustic output of the transducer;
a reference microphone input for receiving a reference microphone signal indicative of the ambient audio sounds;
an error microphone input for receiving an error microphone signal indicative of the output of the transducer and the ambient audio sounds at the transducer; and
a processing circuit that implements an adaptive filter having a response that generates the anti-noise signal from the reference microphone signal to reduce the presence of the ambient audio sounds heard by the listener, wherein the processing circuit implements a coefficient control block that shapes the response of the adaptive filter in conformity with the error microphone signal and the reference microphone signal by adapting the response of the adaptive filter to minimize the ambient audio sounds in the error microphone signal and further adapting the response of the adaptive filter in accordance with a calculated narrow-band-to-full-band ratio, wherein the narrow-band-to-full-band ratio is a function of a narrow-band power of the reference microphone signal divided by a full-band power of the reference microphone signal.

18. The integrated circuit of claim 17, wherein the narrow-band-to-full-band ratio is calculated as a blended average of a previous value of the narrow-band-to-full-band ratio and a quantity equal to a present narrow-band power of the reference microphone signal divided by a present full-band power of the reference microphone signal.

19. The integrated circuit of claim 17, wherein the narrow-band-to-full-band ratio is calculated as a blended average of a previous value of the narrow-band-to-full-band ratio and a quantity equal to a present narrow-band power of the reference microphone signal divided by a quantity equal to a present full-band power of the reference microphone signal minus a present power of reference microphone signal outliers present outside of a frequency range of the narrow-band power.

20. The integrated circuit of claim 17, wherein:
the narrow-band-to-full-band ratio is calculated as a blended average of a previous value of the narrow-band-to-full-band ratio and a quantity equal to a present narrow-band power of the reference microphone signal divided by a present full-band power of the reference microphone signal responsive to a determination that no disturbance is detected on the reference microphone signal; and
the narrow-band-to-full-band ratio is calculated as equal to the previous value of the narrow-band-to-full-band ratio reference microphone signal responsive to a determination that a disturbance is detected on the reference microphone signal.

21. The integrated circuit of claim 17, wherein the narrow-band power comprises a power of the reference microphone signal for frequencies between approximately 50 Hz and approximately 380 Hz.

22. The integrated circuit of claim 17, wherein the processing circuitry adapts the response of the adaptive filter in accordance with the calculated narrow-band-to-full-band ratio by controlling a step size of at least one coefficient of the coefficient control block based on the calculated narrow-band-to-full-band ratio.

23. The integrated circuit of claim 17, wherein the processing circuitry adapts the response of the adaptive filter in accordance with the calculated narrow-band-to-full-band ratio by controlling an adaptive noise control gain of the adaptive filter based on the calculated narrow-band-to-full-band ratio.

24. The integrated circuit of claim 17, wherein the narrow-band power of the reference microphone signal is attributable primarily to ambient noise caused by travel in a vehicle.
